(19) United States
(12) Patent Application Publication
(10) Pub. No.: US 2011/0082796 A1
(43) Pub. Date: Apr. 7, 2011

(54) COPYRIGHT MANAGEMENT SYSTEM

(75) Inventor: Ryuta Mori, Yokohama-shi (JP)

(73) Assignee: CANON KABUSHIKI KAISHA, Tokyo (JP)

(21) Appl. No.: 12/891,410

(22) Filed: Sep. 27, 2010

(30) Foreign Application Priority Data
Oct. 1, 2009 (JP) 2009-229498

(51) Int. Cl. G06F 21/00; G06F 17/30

(52) U.S. Cl. 705/52; 707/812; 707/E17.005

(57) ABSTRACT

A copyright management system for registering a document read by a multifunction peripheral in a database as a copyrighted work and charging a copyright fee for use of the registered document includes a setting unit, a registration control unit, and a notification unit. The setting unit sets attribute information including a monitoring range within which to monitor an update status of the document read by the multifunction peripheral. The registration control unit adds the attribute information set by the setting unit to the document and registers the document with the added attribute information in the database. The notification unit monitors the update status of the document within the monitoring range and notifies an apparatus set as a notification destination in the attribute information of the monitored update status.

### BACKGROUND OF THE INVENTION

1. Field of the Invention

The present invention relates to a copyright management system and, in particular, to a technique related to the registration management of copyright of document data read with a multifunction peripheral and charging of a copyright fee.

2. Description of the Related Art

In recent years, a multifunction peripheral having a plurality of functions such as a print function, copy function, and facsimile function has come into wide use. Furthermore, a technique for managing document data read with the multifunction peripheral as copyrighted works in collaboration with a copyright management server has been realized.

Japanese Patent Application Laid-Open No. 2001-52016, for example, discusses a technique in which document data is divided into component objects and attribute information such as copyright information is managed in units of the component object.

A copyright management system has been also realized in which a document combined by editing (combining) a plurality of documents (hereinafter referred to as a document pack) is produced. The document pack is registered in a database to charge a copyright fee. In a case where a document included in the document pack is used, the copyright management system performs charging processing by acquiring information about charging made for the use of the document (a copyright fee) from the copyright management server.

The above copyright management system, however, has the following problems.

Even if statistical data related to another party's copyright and quoted in a document pack is updated after the document pack is produced, for example, the producer of the document pack does not aware that the statistical data is updated. Therefore, old statistical data remains quoted in the document pack. It is difficult for the producer of the document pack to find out that document data quoted in the document pack is updated.

Even in a case where only a specific place in the produced document pack is updated, other places which are not updated may be charged.

Such problems may be caused not only in the document pack produced by combining a plurality of documents of a plurality of authors but also in a document by one author.

### SUMMARY OF THE INVENTION

The present invention is directed to a copyright management system capable of adequately processing the update of a document produced by quoting another party's copyrighted works.

According to an aspect of the present invention, a copyright management system for registering a document read by a multifunction peripheral in a database as a copyrighted work and charging a copyright fee for use of the registered document includes a setting unit, a registration control unit, and a notification unit. The setting unit sets attribute information including a monitoring range within which to monitor an update status of the document read by the multifunction peripheral. The registration control unit adds the attribute information set by the setting unit to the document and registers the document with the added attribute information in the database. The notification unit monitors the update status of the document within the monitoring range and notifies an apparatus set as a notification destination in the attribute information of the monitored update status.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram of a configuration of a copyright management system according to first and second exemplary embodiments of the present invention.

FIG. 2 is a block diagram illustrating a configuration of hardware of the copyright management system in FIG. 1.

FIG. 3 illustrates a memory map of a random access memory (RAM) in a case where the program according to the exemplary embodiment of the present invention is loaded into the RAM of the copyright management system and can be executed.

FIG. 4 illustrates the contents of data stored in media attached to the copyright management system in FIG. 1.

FIG. 5 is a block diagram illustrating a configuration of hardware of the multifunction peripheral in FIG. 1.

FIG. 6 is a flow chart illustrating the outline of registration and update processes of a document in a first exemplary embodiment of the present invention.

FIG. 7 is a flow chart illustrating the details of a document registration process in step S101 in FIG. 6.

FIG. 8 is a flow chart illustrating the details of an update check process in step S102 in FIG. 6.

FIG. 9 is a flow chart illustrating the details of an update check process in step S103 in FIG. 6.

FIG. 10 is a flow chart illustrating the details of an update registration and charging process in step S104 in FIG. 6.

FIG. 11A illustrates a menu screen for various processes displayed on the multifunction peripheral. FIG. 11B illustrates a menu screen for various settings displayed on the multifunction peripheral. FIG. 11C illustrates a basic screen for copyright system setting.

FIG. 12 illustrates an advanced settings screen for copyright system setting.

FIG. 13A illustrates a display screen for guidance information regarding a scan registration operation. FIG. 13B illustrates an attribute information registration screen.

FIG. 14A illustrates an update region designation screen. FIG. 14B illustrates the update region designation screen of which an update region is designated.

FIG. 15 illustrates an update notification screen.

FIG. 16A illustrates an update document list screen.

FIG. 16B illustrates the update document list screen in which an update document is designated.

FIG. 17 illustrates a preview screen.

FIG. 18 illustrates a copyright system setting screen according to a second exemplary embodiment of the present invention.

FIG. 19 is a schematic diagram of a configuration of a copyright management system according to a third exemplary embodiment of the present invention.

FIG. 20 is a sequence diagram of a document registration process in the third exemplary embodiment.

### DESCRIPTION OF THE EMBODIMENTS

Various exemplary embodiments, features, and aspects of the invention will be described in detail below with reference to the drawings.

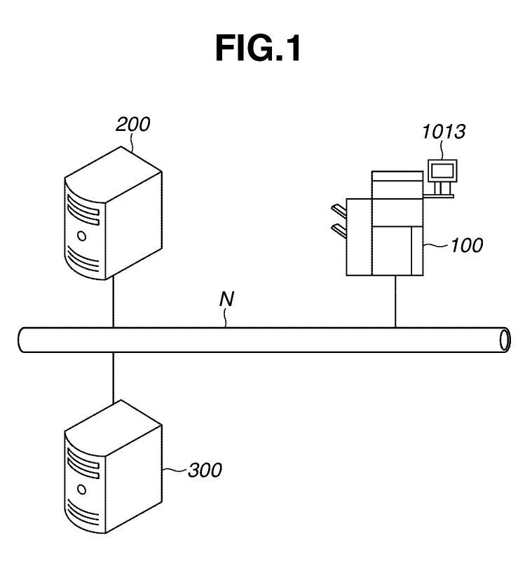

FIG. 1 illustrates a configuration of a copyright management system according to a first exemplary embodiment of the present invention. As illustrated in FIG. 1, a copyright management system 200 is connected for communications to a plurality of multifunction peripherals 100 and a copyright management server 300 via a network N. In the present exemplary embodiment, a local area network (LAN) and the Internet are presumed as the network N. However, other various networks may be used.

The copyright management system 200 is the one for realizing various functions according to the present exemplary embodiment and is formed of a computer. The copyright management system 200 registers document data produced by the multifunction peripheral 100 or a document pack obtained by combining the document data, updates and registers the document data and the document pack, and charges a copyright fee as a charge in connection with the document data or the document pack. The copyright fee may request a monetary payment or other transfer or movement of wealth or value.

The copyright management system 200 has also a function to monitor an update status within a set range of the document such as the registered document pack (document data) and to notify the multifunction peripheral 100 set as a notification destination of the update status.

The multifunction peripheral (MFP) 100 may include a machine, such as a home or office machine, that incorporates functionality of multiple devices in one device, where the one device may have a smaller footprint than the multiple devices and may provide centralized document management, document distribution, and/or document production. The multifunction peripheral 100 has a scan function, print function, various communication functions, and display function. In the present exemplary embodiment, the scan function and the display function occupy a major position. The copyright management server 300 stores International Standard Book Number (ISBN) codes, author information, update information of document data, and detailed charging information in using copyrighted works in units of a copyrighted work and responds to an inquiry on the update information or charging information from the copyright management system 200.

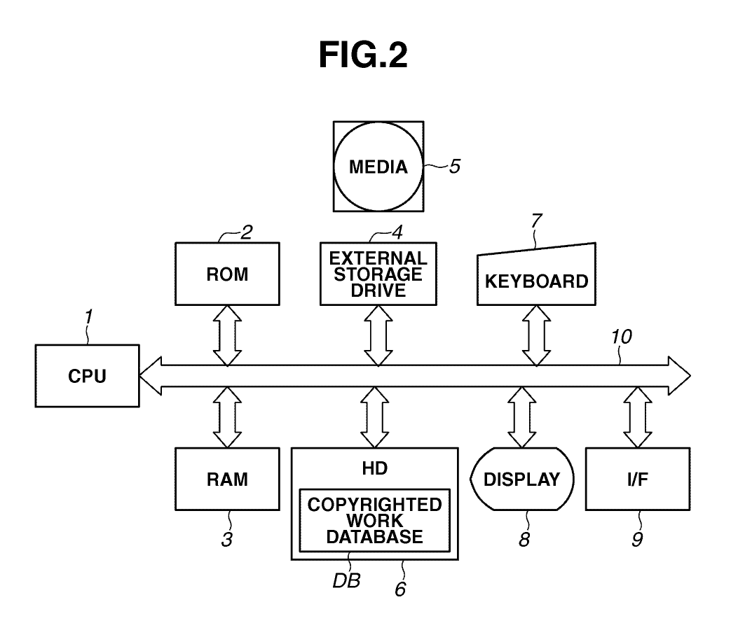

FIG. 2 is a block diagram illustrating a configuration of hardware of the copyright management system 200. A central processing unit (CPU) 1 executes an application program, a printer driver program, an operating system (OS), and a network printer control program, which are stored in a hard disk (HD) 6. The CPU 1 uses a RAM 3 as a work area.

A copyrighted work may include a production such as a literary, artistic, or intellectual production having attached rights, such as a right to copy the work, a right to distribute the work, and/or a right to adapt the work. A copyrighted work database DB is constructed in the HD 6. Document data as copyrighted works associated with attribute information, described below, is registered in the copyrighted work database DB.

A read-only memory (ROM) 2 stores programs such as a basic input/output (I/O) program and various data such as font data used for processing documents and data for a template. An external storage drive 4 can load a program stored in media 5 as an external detachable storage medium into the copyright management system 200.

The media 5 stores a program for performing processing peculiar to the present exemplary embodiment, described below, and its related data. Various media such as a flash memory card, a USB memory, and an SD card can be used as the media 5.

The HD 6 stores an application program for general copyright management, a printer driver program, an OS, a control program for controlling various operations such as communication control and display control, and related programs. A keyboard 7 is used to input various data and commands. A display 8 performs the echo display of information input from the keyboard 7 and displays the state of the copyright management system 200.

The above various devices transfer data and commands to and from each other via a system bus 10. The copyright management system 200 can communicate with the multifunction peripheral 100 and the copyright management server 300 via the network interface (hereinafter referred to as I/F) 9.

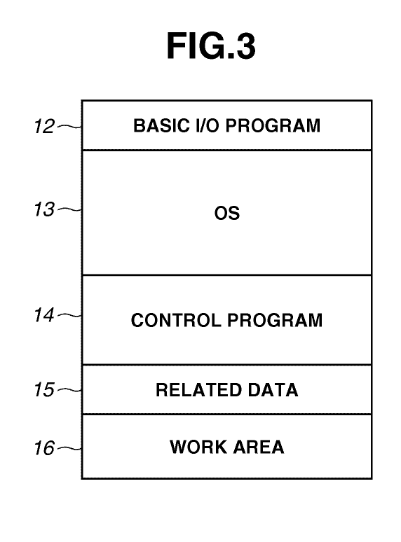

FIG. 3 illustrates the memory map of the RAM 3 in a case where the program according to the present exemplary embodiment is loaded into the RAM 3 of the copyright management system 200 and can be executed. A basic I/O program 12 is the one having an initial program loading (IPL) function to read an OS 13 from the HD 6 to the RAM 3, when the power source of the copyright management system 200 is turned on, to start the operation of the OS 13.

A control program 14 and related data 15 as well as the basic I/O program 12 and the OS 13 are loaded into the RAM 3 and a work area 16 for executing the control program 14 is prepared. The control program 14 loaded into the RAM 3 includes an application program according to the present exemplary embodiment described below. The related data 15 includes data related to the control program 14 and in particular the application program according to the present exemplary embodiment.

The program for performing processing peculiar to the present exemplary embodiment described below and its related data may be stored not in the external media 5, but in the built-in ROM 2 or HD 6. The program for performing processing peculiar to the present exemplary embodiment and its related data may be stored in a floppy disk (FD), a compact disc (CD)-ROM, a digital versatile disc (DVD), or an integrated circuit (IC) memory card. In a case where the program and its related data are stored in the ROM 2, the stored information is regarded as a part of the above memory map and directly executed by the CPU to allow rapidly starting the processing peculiar to the present exemplary embodiment.

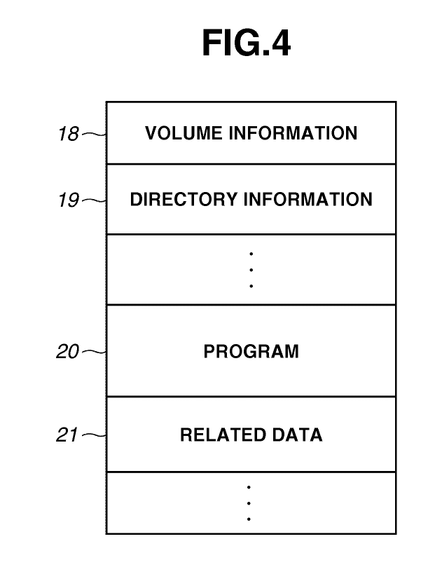

FIG. 4 illustrates the contents of data stored in the media 5 attached to the copyright management system 200. As illustrated in FIG. 4, the media 5 stores volume information 18, directory information 19, a program 20, and related data 21.

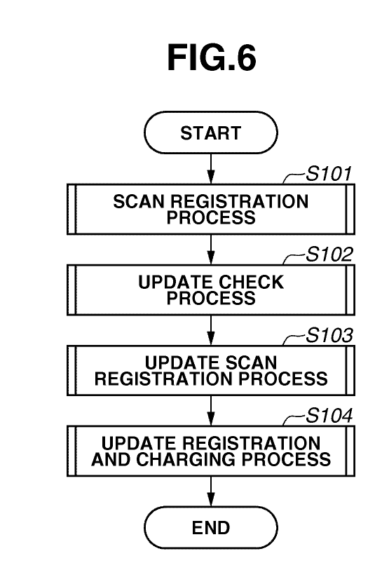

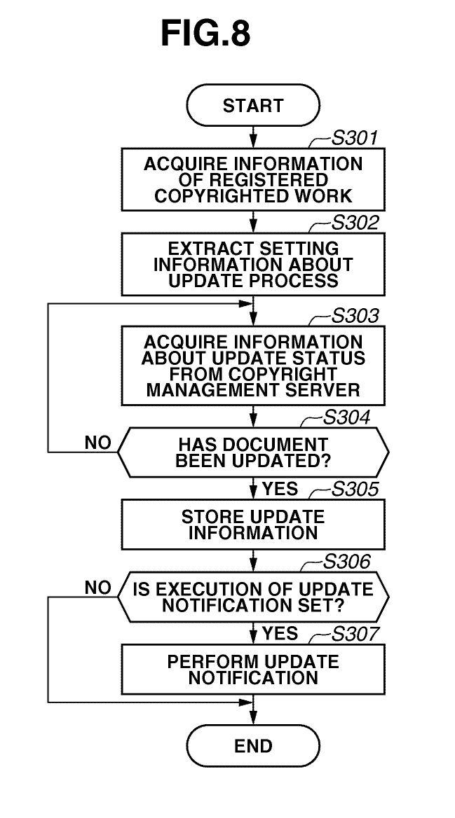

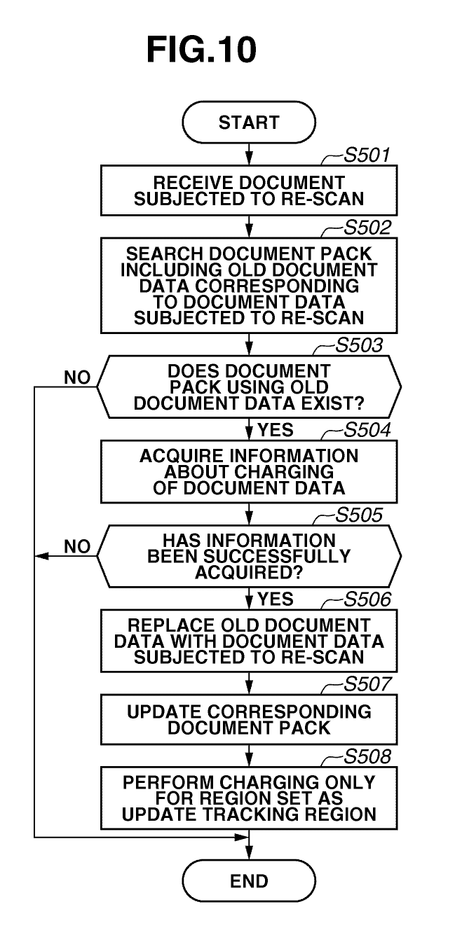

The volume information 18 is the one related to data stored in the media 5. The directory information 19 is the one related to data (file data) stored in the media 5. The program 20 is the one (actually a program code) corresponding to processing related to the flow charts in FIGS. 8 and 10 executed by the copyright management system 200 and processing to be executed by the copyright management system 200 among processes related to the flow charts in FIGS. 6, 7, and 9. The related data 21 is the one related to the program 20.

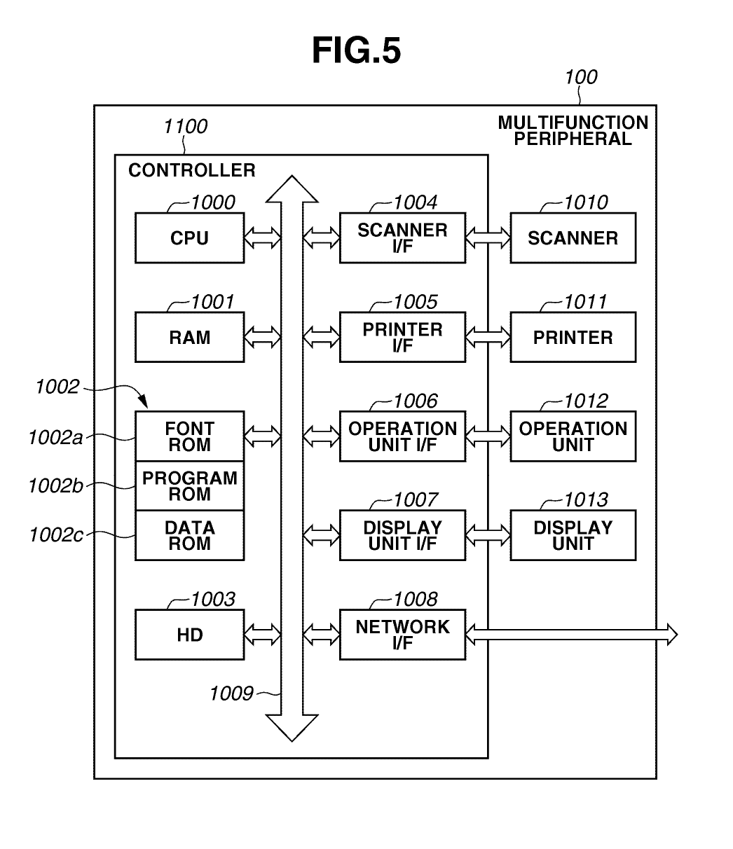

FIG. 5 is a block diagram illustrating a configuration of hardware of the multifunction peripheral 100. The multifunction peripheral 100 includes a controller 1100, a scanner 1010, a printer 1011, an operation unit 1012, and a display unit 1013. The controller 1100 controls an image reading process by the scanner 1010 and a printing process by the printer 1011 according to user's instructions from the operation unit 1012. The controller 1100 controls the communication process of the copyright management system 200 having a network communication function with other apparatuses.

The controller 1100 includes a CPU 1000, a RAM 1001, a ROM 1002, a HD 1003, a scanner interface (I/F) 1004, a printer I/F 1005, an operation unit I/F 1006, a display unit I/F 1007, and a network I/F 1008. The devices are connected to each other by a bus 1009. The CPU 1000 transfers data and commands to and from each device via the bus 1009 or the bus 1009 and the I/Fs 1004 to 1008 to realize various functions such as a scan function (image reading function), a print function, a communication function, and a display function.

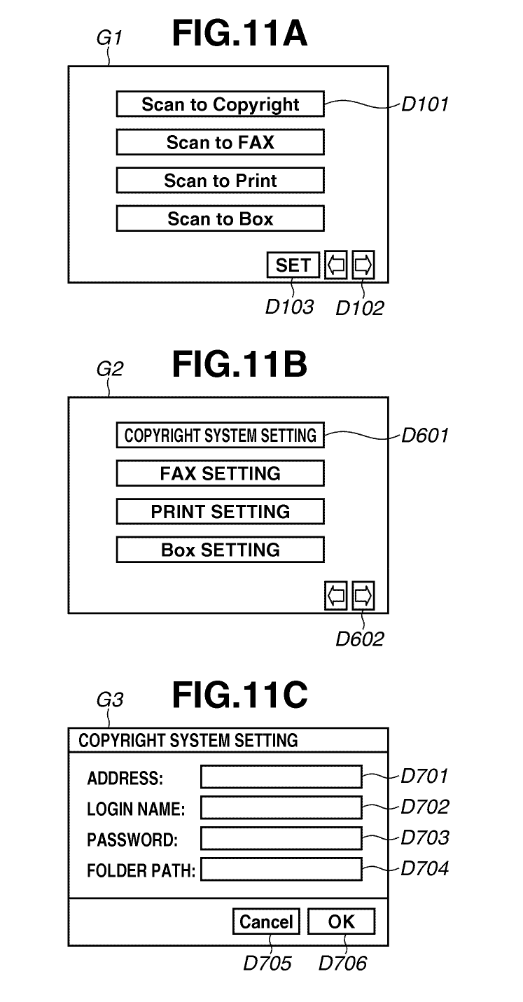

The CPU 1000 performs display control for displaying graphical user interface (GUI) screens illustrated in FIGS. 11 to 18 on the display unit 1013. The RAM 1001 is used as a work area when the CPU 1000 executes programs related to various functions.

The ROM 1002 includes a font ROM 1002a, a program ROM 1002b, and a data ROM 1002c. The font ROM 1002a stores character pattern data related to various fonts associated with character codes. The character pattern data is used in a case where the character data in the document data read by the scanner 1010 is converted into character codes and transmitted to the copyright management system 200.

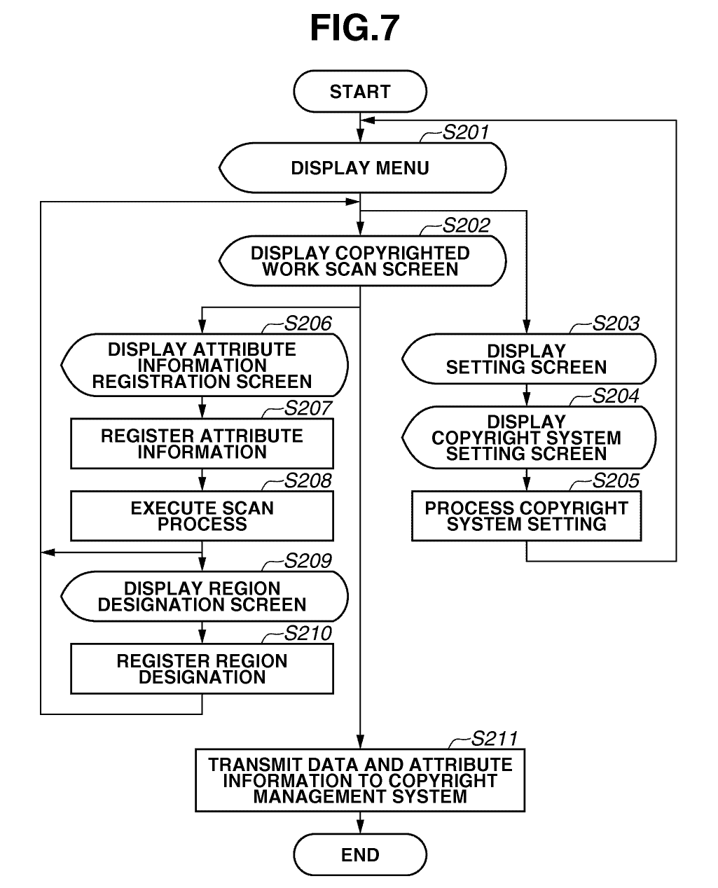

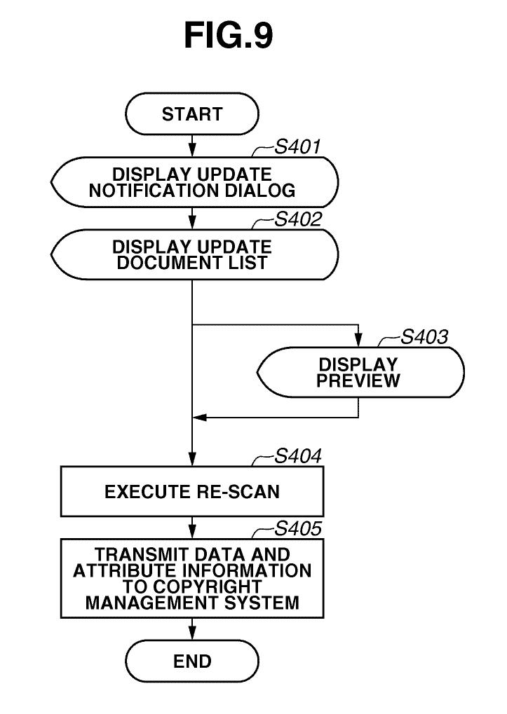

The program ROM 1002b stores programs for realizing various functions such as a scan function, a print function, and a communication function. The program includes an application program related to flow charts in FIGS. 7 and 9. The data ROM 1002c is used as a substitute memory of the HD 1003 if the HD 1003 is not prepared.

The registration and update process of a document peculiar to the present exemplary embodiment is described in detail below. The outline of the registration and update process of a document in the copyright management system of the present exemplary embodiment is described based on a flow chart in FIG. 6.

For example, an editor of a document pack or a producer of a document forming a document pack operates buttons on a GUI screen displayed on the operation unit 1012 or the display unit 1013 of the multifunction peripheral 100. In step S101, the CPU 1000 of the multifunction peripheral 100 performs a scan registration process according to the operation of the operation unit 1012.

In the scan registration process, the CPU 1000 causes the scanner 1010 to scan a document, attaches the attribute information of the document data input from the GUI screen to the document data and sends the document data to the copyright management system 200.

The attribute information of the document data includes information related to the update monitoring of the document data. The scan registration process is described below in detail based on a flow chart in FIG. 7.

In step S102, the copyright management system 200 registers the document data sent from the multifunction peripheral 100 and their attribute information in the copyrighted work database DB and checks if the document registered in the copyrighted work database DB is updated. The check process is the one for checking if, in a case where statistical data related to another party's copyright is used in the produced and registered document pack, for example, the statistical data is updated.

In this case, the CPU 1 of the copyright management system 200 inquires of the copyright management server 300 whether the document is updated. The CPU 1 notifies the multifunction peripheral 100 requesting the scan registration of the document data of the check result. The update check process is described below in detail based on a flow chart in FIG. 8. The check result is displayed on the display unit 1013 of the multifunction peripheral 100 when the registrant (producer) of the document logs in the UI screen of the copyright management system 200 via the multifunction peripheral 100.

In step S103, in a case where the producer of the document looks at the update check result displayed on the display unit 1013 to be aware that a part of the document such as the document pack produced by the producer is updated, the producer re-scans a new updated document to perform update registration.

Actually, the update registration is performed by transmitting the document data subjected to re-scan from the multifunction peripheral 100 to the copyright management system 200. The update registration is described below in detail based on a flow chart in FIG. 9.

Statistical data related to another party's copyright subjected to the update check is not always registered in the copyright management system 200 registering the document, but often in other copyright management systems. On the other hand, the copyright management server 300 collects and manages copyright information about documents registered in a large number of copyright management systems and grasps the update status of the document registered in copyright management systems other than the copyright management system 200 illustrated in FIG. 1.

In step S104, the copyright management system 200 receives document data subjected to re-scan from the multifunction peripheral 100 and performs a document update registration process and charging process. In the document update registration process, the copyright management system 200, old document data corresponding to document data subjected to re-scan is replaced with the document data subjected to re-scan. The replacement process is actually performed with overwriting.

In the charging process, the copyright management system 200 charges a copyright fee and makes a charge not for the whole document data or the whole page, but only for the range set as the above monitoring range. In this case, the copyright management system 200 acquires information about a copyright fee to perform the charging process. A replacement range does not always need to conform to a charging range. The replacement range may be wider than the charging range.

The document update process and the charging process are described below in detail based on a flow chart in FIG. 8.

The scan registration process in step S101 in FIG. 6 is described in detail based on the flow chart of FIG. 7 and FIGS. 11A to 11C to FIGS. 14A and 14B.

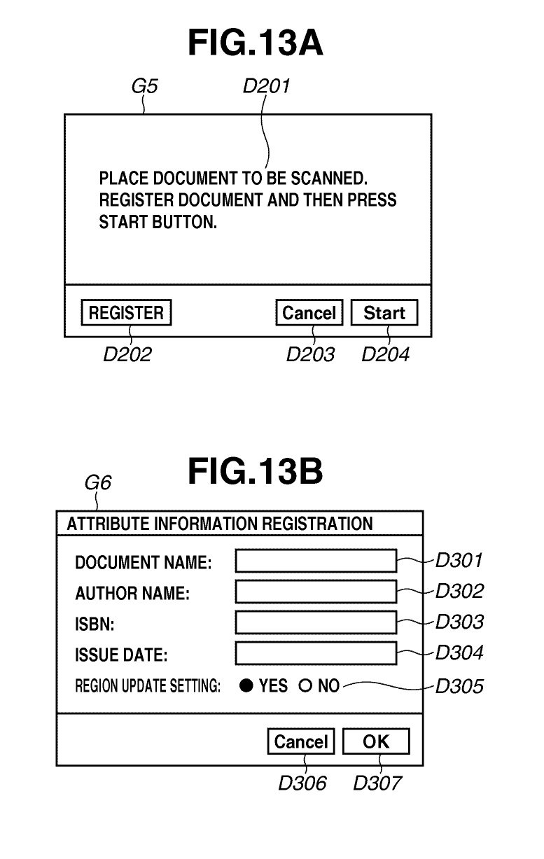

In step S201, when the multifunction peripheral 100 is started by operating the operation unit 1012, the CPU 1000 of the multifunction peripheral 100 displays a process menu screen G1 illustrated in FIG. 11A on the display unit 1013. In step S202, selecting a menu of “Scan to Copyright” (D101) causes the CPU 1000 to display a display screen G5 of guidance information regarding a scan registration operation illustrated in FIG. 13A on the display unit 1013.

In step S203, when a setting button D103 in the process menu screen G1 illustrated in FIG. 11A is clicked, the CPU 1000 displays a setting screen G2 illustrated in FIG. 11B on the display unit 1013. In a case where a document is scanned by the multifunction peripheral 100 to register the data in the copyright management system 200, various information needs to be previously set in relation to the use of the copyright management system 200. The user usually clicks “copyright system setting” (D601) on the setting screen G2 illustrated in FIG. 11B. In step S204, the CPU 1000 displays a copyright system setting screen G3 illustrated in FIG. 11C in response to the click operation.

In the copyright system setting screen G3, address, login name, password, and folder path can be input to input boxes D701 to D704, each corresponding thereto, and set. The above address is an IP address of the copyright management server 300. The login name and the password are used for logging in the copyright management system 200. The folder path is the one for storing scanned document data.

If the user discards data input at present to the input boxes D701 to D704 or data input in the past, the user clicks a “Cancel” button D705. If the update status of document data, image, or statistical data quoted from other copyrighted works is to be tracked on the document scanned and registered this time, the user clicks an “OK” button D706.

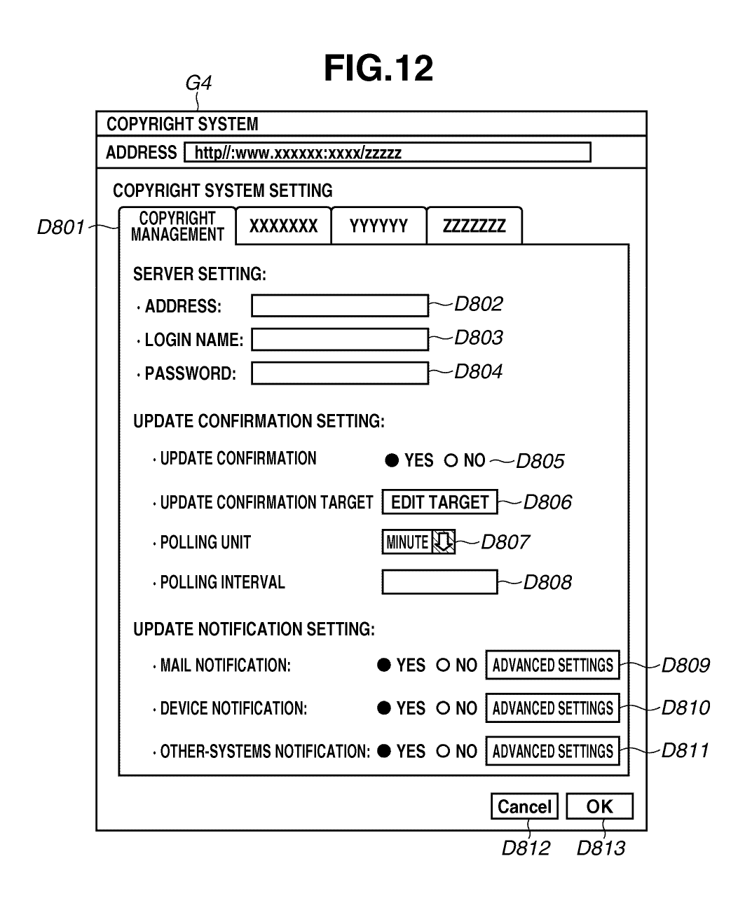

In step S205, when the “OK” button D706 on the copyright system setting screen G3 is clicked, the CPU 1000 displays a advanced settings screen G4 of the copyright management system 200 illustrated in FIG. 12 on the display unit 1013. In step S205, the user clicks a “copyright management” tab D801 on the advanced settings screen G4 of the copyright management system 200 to perform an update confirmation setting and an update notification setting. If setting data is input to the input boxes of the copyright system setting screen G3 and then the “OK” button D706 is clicked, the input data is reflected in the advanced settings screen G4 (D802 to D804) of the copyright management system 200 and displayed without any input operation.

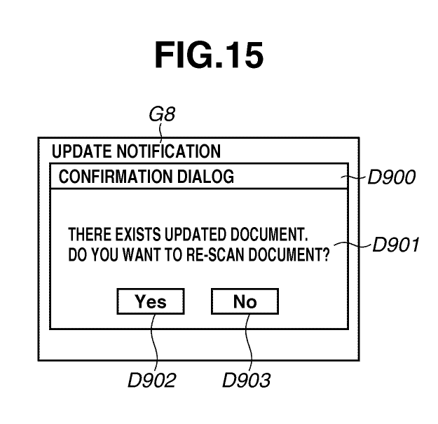

As an update confirmation setting, there can be set an update confirmation “Yes” or “No” (D805), an update confirmation target (D806), a polling unit (D807), and a polling interval (D808). The update confirmation “Yes” is set to allow the user to grasp the update status via an update notification screen G8 illustrated in FIG. 15 on the display unit 1013, so that the user does not need to check the update status.

The update confirmation target (D806) does not need setting in units of pages. Only a part of statistical data quoted from other copyrighted works in a page is set to allow reducing a charging amount of copyright fee. As the polling unit (D807), “minute,” “time,” or “day,” for example, can be set in the pull-down menu. As the polling interval (D808), a numeric value of time interval such as 1, 2, or the like, for example, can be set.

For example, if “day” is set as the polling unit (D807) and “7” is set as the polling interval (D808), the copyright management system 200 performs polling on the copyright management server 300 at a time interval of seven days to acquire update information. Thus, the boxes D807 and D808 are use to set time interval information in inquiring of the copyright management server 300 the update status.

As an update notification setting, there can be set a mail notification “Yes” or “No” (D809), a device notification “Yes” or “No” (D810), and other-systems notification “Yes” or “No” (D811). The notification “Yes” is set and the corresponding advanced setting is clicked to display an advanced setting screen. This allows setting the mail address of notification destination in the case of the mail notification, the IP address or host name of a notification destination device in the case of the device notification, for example.

If a “cancel” button D812 on the advanced settings screen G4 of the copyright management system 200 is clicked, and even if some sort of setting input is performed on the advanced settings screen G4 of the copyright management system 200, the input is cancelled and the process menu screen G1 illustrated in FIG. 11A appears. If an “OK” button D813 on the advanced settings screen G4 of the copyright management system 200 is clicked, item data set on the advanced settings screen G4 is determined as effective and the screen G4 returns to the process menu screen G1.

In step S206, if the user clicks a “register” button D202 based on guidance information on a display screen G5 indicating guidance information regarding a scan operation illustrated in FIG. 13A, the CPU 1000 displays an attribute registration screen G6 illustrated in FIG. 13B on the display unit 1013.

In step S207, “document name” (D301), “author name” (D302), “ISBN” (D303), and “issue date” (D304) of the document subjected to the scan registration process can be set and registered in the attribute registration screen G6 as the attribute information of the document. A region update setting “Yes” or “No” (D305) can also be set and registered in the attribute registration screen G6 as the attribute information of the document.

If the region update setting “Yes” D305 is set and an “OK” button D307 is clicked to perform determination, the document data subjected to the scan is displayed on the display unit 1013 after the scan of the document and an OCR process in step S208 about a necessary region are completed.

More specifically, if a “cancel” button D306 or the “OK” button D307 on the attribute registration screen G6 illustrated in FIG. 13B is clicked, the CPU 1000 returns to step S202 to display again the display screen G5 indicating guidance information regarding the above-described scan registration operation.

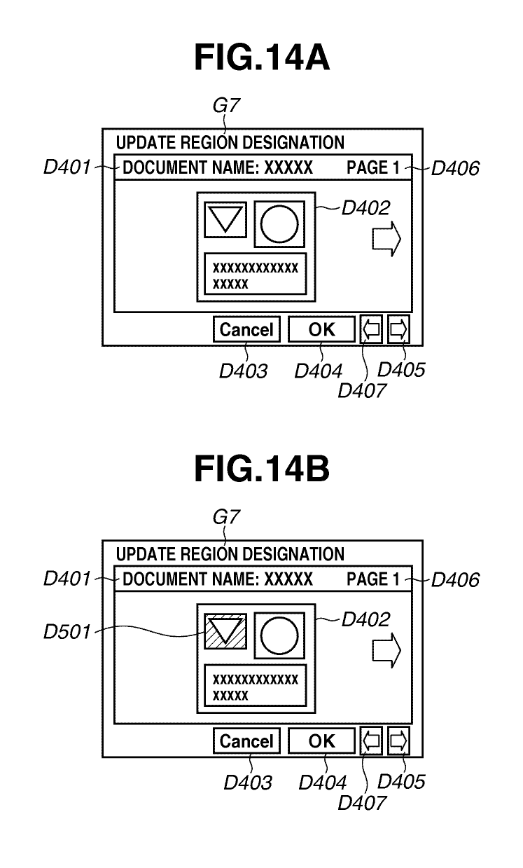

In step S208, if the user sets a document on a document positioning plate or an automatic document feeding device according to the guidance information and clicks a “start” button D204 on the display screen G5, the CPU 1000 scans the document and performs the OCR process if required. In step S209 the CPU 1000 displays an update region designation screen G7 illustrated in FIG. 14A on the display unit 1013.

The update region designation screen G7 displays the “document name” registered in the attribute registration screen G6 (D401). The update region designation screen G7 displays the presently scanned document data (D402) at the center thereof. The page change of the presently scanned document data can be performed with a page back button D407 and a page advance button D405. A page number (D406) is displayed on the right of the document name D401.

The presently scanned document data (D402) is displayed with the text region, graphic region, and image region, recognized at the time of OCR process, recognizably encompassed with the respective frames. This facilitates the user to set a region for tracking the update status in units of the regions of the frames, in other words, a monitoring region for monitoring the update status. Here, a display control unit may discriminably display the text region and the image region so that the text region and the image region are capable of being perceived as different or distinct. Instep S210, the CPU 1000 of the multifunction peripheral 100 receives the setting.

In this case, as illustrated in the update region designation screen G7 illustrated in FIG. 14B, an update tracking region (D501) set as the monitoring region changes in background color to allow easily confirming that a desired update tracking region is appropriately specified. The monitoring region does not always need to be set in units of pages, but may be set in units of chapters, graphics, or sentences smaller than in unit of pages. In step S207, on the other hand, if the region update setting “NO” D305 is set and the “OK” button D307 is clicked to perform determination, the processing proceeds to step S202 after the scan of the document and an OCR process in step S208 about a necessary region are completed.

In step S211, if a “cancel” button D403 or an “OK” button D404 on the update region designation screen G7 are clicked, the CPU 1000 transmits the presently scanned document data and the attribute information to the copyright management system 200.

In this case, if the “cancel” button D403 on the update region designation screen G7 is clicked, the update tracking region information is not transmitted and only the attribute information related to other settings is transmitted. If the “OK” button D404 on the update region designation screen G7 is clicked, the update tracking region information is transmitted along with the attribute information related to other settings and the document data.

The update check process in step S102 in FIG. 6 is described in detail based on a flow chart in FIG. 8 and on FIG. 15.

In step S301, the CPU 1 of the copyright management system 200 acquires information of copyrighted works registered in the copyrighted work database DB, i.e., documents such as document packs. The acquired information includes identification information for identifying copyrighted works and information as to whether copyrighted works are used in a document pack and whether update information is checked.

In step S302, the CPU 1 extracts setting information about an update process, more specifically, a polling interval and notification destination information at the update detection. In step S303, the CPU 1 acquires information about the update status of a document subjected to update check and registered to be updated from the copyright management server 300. In this case, the CPU 1 acquires the information about the update status at the set polling interval.

In step S304, if the CPU 1 determines that the document subjected to update check and registered to be updated has been updated (YES in step S304), then in step S305, the CPU 1 stores information about the update contents in the RAM 3 or the HD 6. In step S306, if there is setting information that a notification of the updated document is made, then in step S307, the CPU 1 notifies that updating is made based on the setting information.

For example, suppose that the device notification “Yes” is set as the update notification setting on the copyright system setting screen G4 in FIG. 12 and the display unit 1013 of the multifunction peripheral 100 is set as advanced settings. In this case, the update notification screen G8 illustrated in FIG. 15, for example, is displayed on the display unit 1013 of the multifunction peripheral 100.

The update scan registration process in step S103 in FIG. 6 is described in detail based on a flow chart in FIG. 9 and on FIGS. 15 to 17.

In step S401, when the CPU 1000 of the multifunction peripheral 100 receives the update notification from the copyright management system 200, the CPU 1000 displays the update notification screen G8 illustrated in FIG. 15, for example, on the display unit 1013 when a user related to the update notification (for example, a producer of a document pack) logs in the copyright management system 200. The update notification screen G8 displays a confirmation dialog D900, which includes a message D901 stating the existence of an update document and an inquiry as to whether re-scan is executed, a “Yes” button D902, and a “No” button D903.

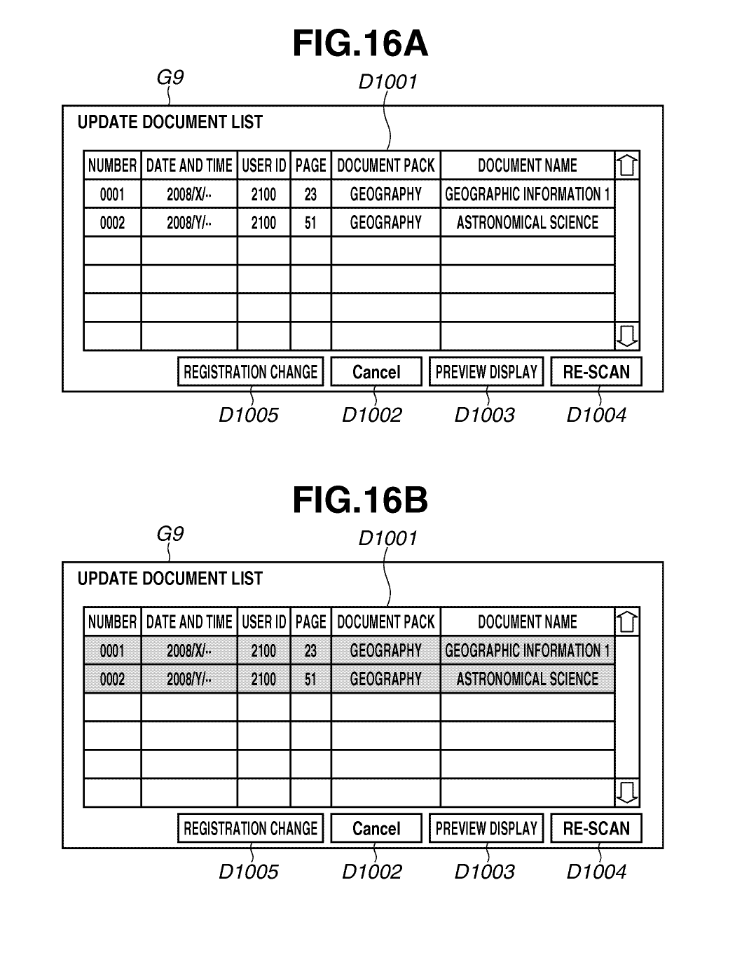

In step S402, if the “Yes” button D902 on the update notification screen G8 is clicked, the CPU 1000 considers that the user issues instructions for the display of an update document list screen, and displays an update document list screen G9 illustrated in FIG. 16A on the display unit 1013.

The update document list screen G9 displays an update document list D1001, a “cancel” button D1002, a “preview display” button D1003, a “re-scan” button D1004, and a “registration change” button D1005. The update document list D1001 displays a document quoting an updated document or information about a document pack (a user ID, page, document pack or not, document name).

The user usually selects a desired document from the update document list D1001, and determines whether to execute re-scan after confirming a re-scan document with a preview or whether to execute re-scan without any preview. The document selected from the update document list D1001 is changed in background color as illustrated in FIG. 16B.

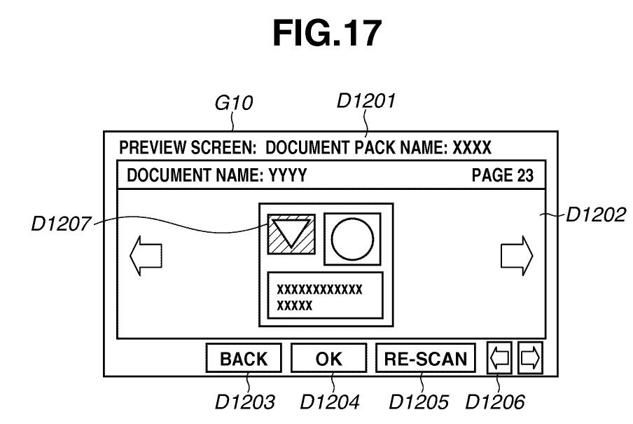

In step S403, if a “preview display” button D1003 on the update document list screen G9 is clicked, the CPU 1001 displays a preview screen G10 illustrated in FIG. 17 on the display unit 1013.

The preview screen G10 displays a document D1202 to which a document pack name D1201, a document name, and a page number of the document selected on the update document list D1001 are added. In addition to the above, the preview screen G10 displays operation buttons such as a “back” button D1203, an “OK” button D1204, a “re-scan” button D1205, and a “page operation” button D1206. A document (region) D1207 to be updated, i.e., to be re-scanned in the previewed document D1202 is changed in background color.

In step S404, if the “re-scan” button D1004 on the update document list screen G9 or the “re-scan” button D1205 on the preview screen G10 is clicked, the CPU 1001 executes re-scan. In step S405, the CPU 1001 transmits the re-scanned document data and attribute information to the copyright management system 200.

Thus, the user can grasp the update status of each document of a document pack without tracking the update status and can execute update registration at an appropriate timing. When the updated document is re-scanned, a page to be updated of an old document yet to be updated is previewed on the display unit 1013 of the multifunction peripheral 100, so that a document to be re-scanned is not mistaken.

The update registration and charging process in step S104 in FIG. 6 is described in detail based on a flow chart in FIG. 10.

In step S501, the CPU 1 of the copyright management system 200 receives document data subjected to re-scan from the multifunction peripheral 100. In step S502, the CPU 1 searches for a document pack using old document data corresponding to document data subjected to re-scan.

In step S503, if the document pack using old document data exists in the copyrighted work database DB (YES in step S503), then in step S504, the CPU 1 acquires charging information about the document data subjected to re-scan from the copyright management server 300. In this case, it is desirable to acquire not charging information about one-page of the document data subjected to re-scan, but charging information about a region set as the update tracking region.

In step S505, if the CPU 1 successfully acquires the charging information about the document data subjected to re-scan (YES in step S505), then in step S506, the CPU 1 replaces the old document data with the document data subjected to re-scan. In step S507, the CPU 1 updates the corresponding document pack. The replacement process and the update process are performed in units of pages.

The reason the replacement process in step S506 and the update process in step S507 are performed separately is that it is presumed that the old document data is registered in the copyrighted work database DB of the copyright management system 200 separately from the document pack. Therefore, if the old document data is not registered in the copyrighted work database DB of the copyright management system 200 separately from the document pack, the replacement process in step S506 is not required.

In step S508, the CPU 1 performs the charging process only in the region set as the update tracking region (monitoring region) in the document data subjected to re-scan. Thus, charging a copyright fee not in units of pages but in units of regions which may be actually updated allows making it appropriate to charge a copyright fee and accelerates the update registration of statistical data in a document pack, for example.

In the first exemplary embodiment, the document data subjected to re-scan is overwritten on the copyrighted work database DB to perform the update process, and update history information about the document data subjected to re-scan cannot be stored in the copyright management system 200. In a second exemplary embodiment of the present invention, the document data subjected to re-scan, i.e., the document data to be updated and tracked, is stored in the copyright management system 200.

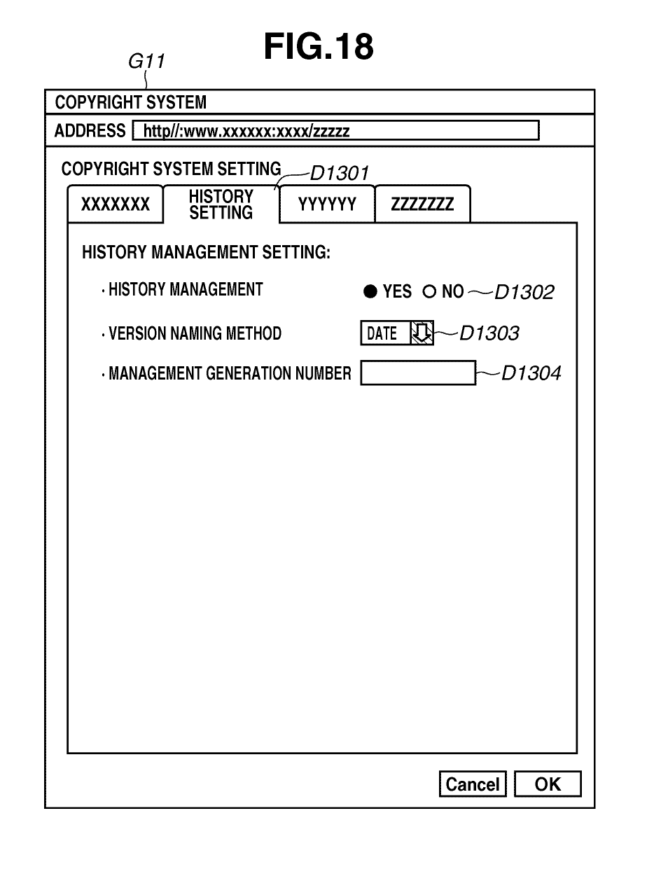

As illustrated in FIG. 18, a “history setting” tab D1301 is provided on a copyright system setting screen G11. Clicking the “history setting” tab D1301 performs a history management setting. Setting items for the history management setting include a history setting “Yes” or “NO” (D1302), a version naming method D1303, and a management generation number D1304.

If the history setting “NO” is set, the document data subjected to re-scan is overwritten on the copyrighted work database DB to perform the update process, as is the case with the first exemplary embodiment. If the history setting “Yes” is set, the document data subjected to re-scan is not overwritten on the copyrighted work database DB, but sequentially registered and stored in a region on the HD 6 separately from the region where the copyrighted work database DB is constructed, for example.

As the version naming method, a registration date, an edition number (e.g., a third edition), and so forth, for example, may be used. The management generation number D1304 is an item for setting the generation number of document data storable as a history. Document data with a value specified with the management generation number D1304 can be registered and stored in the same document. If the document data with a generation number equal to or higher than the specified generation number is registered and stored, the latest generation of document data is overwritten on the earliest generation thereof.

In the first and second exemplary embodiments, the copyright management system 200 does not function as a web server, and the attribute information of a document is input using the GUI provided by the controller 1100 and the display unit I/F 1007 of the multifunction peripheral 100.

In a third exemplary embodiment of the present invention, a copyright management system is configured to function as a web server and the attribute information of a document is input not only from a multifunction peripheral, but from a personal computer (PC).

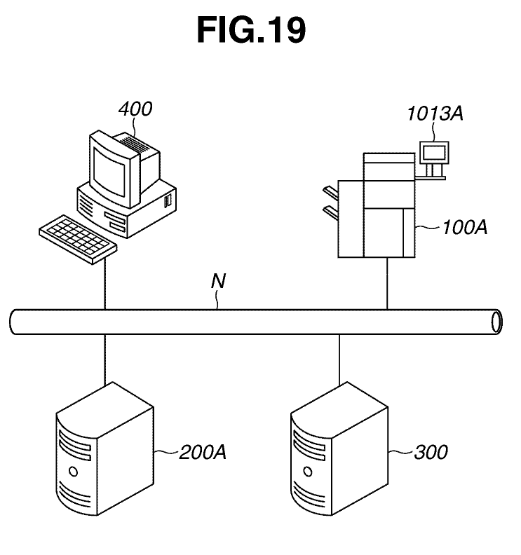

More specifically, in the third exemplary embodiment, as illustrated in FIG. 19, a multifunction peripheral 100A and a PC 400 are connected to a copyright management system 200A and the copyright management server 300 via the network N including the Internet. The multifunction peripheral 100A has a web browser and can display the web page of the copyright management system 200A on the display unit 1013, which is formed of a liquid crystal display panel. The PC 400 also has a web browser and can display the web page of the copyright management system 200A on a display unit (not illustrated). The web page of the copyright management system 200A displayed on the multifunction peripheral 100A and the PC 400 is illustrated in FIGS. 12 to 18.

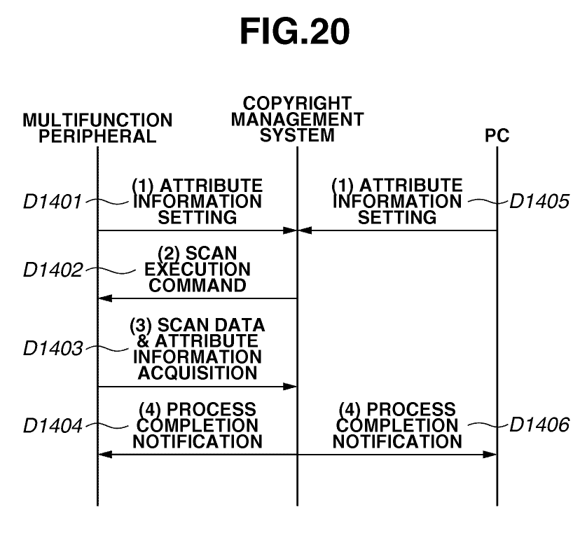

Document registration process in the third exemplary embodiment is described below based on a sequence diagram in FIG. 20. There is described a case where a document is registered in the copyright management system 200A from the multifunction peripheral 100A.

In step D1401, the user accesses the web page (not illustrated) of the copyright management system 200A via the web browser of the multifunction peripheral 100A. The user follows a link on the web page to display the display screen G5 of guidance information in FIG. 13A, the attribute information registration screen G6 in FIG. 13B, the advanced settings screen G4 of the copyright management system 200 in FIG. 12, and the update region designation screen G7 in FIGS. 14A and 14B on the display unit 1013. The user sets the above-described various attribute information on the screens, sets a document, then clicks the “OK” buttons D813 or D404 on the advanced settings screen G4 or the update region designation screen G7, respectively, and clicks the “start” button D204 in FIG. 13A.

In step D1402, this click causes the copyright management system 200A to give the multifunction peripheral 100A instructions to execute scan. In step D1403, the multifunction peripheral 100A adds attribute information related to setting to the scanned document data and transmits the data to the copyright management system 200A. In step D1404, the copyright management system 200A registers the document data and the attribute information transmitted from the multifunction peripheral 100A in the database DB and notifies the multifunction peripheral 100A of the completion of the registration.

A case where a document is registered in the copyright management system 200A from the PC 400 is also almost similar in sequence to the case where a document is registered in the copyright management system 200A from the multifunction peripheral 100A.

In step D1405, the user accesses the web page (not illustrated) of the copyright management system 200A via the web browser of the PC 400. The user follows a link on the web page to display the display screen G5 of guidance information in FIG. 13A, the attribute information registration screen G6 in FIG. 13B, the advanced settings screen G4 of the copyright management system 200 in FIG. 12, and the update region designation screen G7 in FIGS. 14A and 14B on the display unit 1013. The user sets the above-described various attribute information on the screens, clicks the “OK” buttons D813 or D404 on the advanced settings screen G4 or the update region designation screen G7, respectively, and clicks the “start” button D204 in FIG. 13A. In step D1402, this click causes the copyright management system 200A to give the multifunction peripheral 100A instructions to execute scan.

The user moves from the PC 400 to the multifunction peripheral 100A, sets the document to be scanned, and presses a predetermined hardware key such as an enter key, for example, to execute the scan of the document. In step D1403, the multifunction peripheral 100A adds attribute information related to setting to the scanned document data and transmits the data to the copyright management system 200A. In step D1406, the copyright management system 200A registers the document data and the attribute information transmitted from the multifunction peripheral 100A in the database DB and notifies the PC 400 of the completion of the registration.

In the third exemplary embodiment, if a setting operation such as the copyright system setting is performed with the multifunction peripheral 100A, it is desirable that the multifunction peripheral 100A is notified of the updating. If a setting operation such as the copyright system setting is performed with the PC 400, it is desirable that the PC 400 is notified of the updating.

However, if a setting operation such as the copyright system setting is performed with the multifunction peripheral 100A, the PC 400 may be notified of the updating. If a setting operation such as the copyright system setting is performed with the PC 400, the multifunction peripheral 100A may be notified of the updating.

The present invention is not limited to the first to third exemplary embodiments but includes integrally mounting the functions of the copyright management system 200 and the copyright management server 300, for example, into a single computer (server).

If the document subjected to update is registered in the copyright management system 200, for example, the document maybe replaced by merely issuing instructions for replacement without re-scan instead of replacing the document by re-scan.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In an example, an aspect of the present invention can also be realized by computer-readable medium having stored thereon, a program that causes a copyright management system to perform a method disclosed herein to register a document read by a multifunction peripheral in a database as a copyrighted work and to charge a copyright fee for use of the registered document.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-229498 filed Oct. 1, 2009, which is hereby incorporated by reference herein in its entirety.

What is claimed is:

1. A copyright management system for registering a document read by a multifunction peripheral in a database as a copyrighted work and charging a copyright fee for use of the registered document, the copyright management system comprising:
a setting unit configured to set attribute information including a monitoring range within which to monitor an update status of the document read by the multifunction peripheral;
a registration control unit configured to add the attribute information set by the setting unit to the document and to register the document with the added attribute information in the database; and
a notification unit configured to monitor the update status of the document within the monitoring range and to notify an apparatus set as a notification destination in the attribute information of the monitored update status.

2. The copyright management system according to claim 1, further comprising:
a charging unit configured to charge a copyright fee only for the monitoring range in a case where a request is received to replace the document within the monitoring range with a document subjected to update and to re-register the document subjected to update in the database in response to the notification unit notifying the apparatus of the monitored update status.

3. The copyright management system according to claim 1, wherein the notification unit acquires the update status of the document within the monitoring range for notification by transmitting the attribute information to a management server, which is configured to manage a copyright fee of a copyrighted work, to inquire of the management server about the update status.

4. The copyright management system according to claim 3, wherein the notification unit acquires the update status of the document within the monitoring range for notification by inquiring of the management server at a time interval corresponding to time interval information included in the attribute information.

5. The copyright management system according to claim 1, further comprising:
a display instruction unit configured to transmit, in a case where the document within the monitoring range has been updated, the document before being updated within the monitoring range to the multifunction peripheral.

6. The copyright management system according to claim 1, further comprising:
a display control unit configured to discriminably display a text region and an image region of the document read by the multifunction peripheral.
